(19) United States
(12) Patent Application Publication
(10) Pub. No.: US 2026/0052321 A1
(43) Pub. Date: Feb. 19, 2026

(54) IMAGE SENSOR

(71) Applicant: SAMSUNG ELECTRONICS CO., LTD., Suwon-si (KR)

(72) Inventors: Kyungmin KIM, Suwon-si (KR); Youngtae JANG, Suwon-si (KR); Minsun KEEL, Suwon-si (KR)

(73) Assignee: SAMSUNG ELECTRONICS CO., LTD., Suwon-si (KR)

(21) Appl. No.: 19/071,110

(22) Filed: Mar. 5, 2025

(30) Foreign Application Priority Data
Aug. 16, 2024 (KR) 10-2024-0109644

(51) Int. Cl. H04N 25/59; H04N 25/51; H04N 25/709; H04N 25/771

(52) U.S. Cl. CPC H04N 25/59; H04N 25/51; H04N 25/709; H04N 25/771

(57) ABSTRACT

Provided is an image sensor including a plurality of pixels and a peripheral circuit connected to the plurality of pixels, the peripheral circuit being configured to drive the plurality of pixels, wherein each of the plurality of pixels includes a photodiode and a pixel circuit configured to output a signal corresponding to electric charges generated by the photodiode, and the pixel circuit includes a floating diffusion node configured to store the electric charges, a transfer transistor between the photodiode and the floating diffusion node, a gain control transistor connected to the floating diffusion node, a capacitor and a first switch transistor between the gain control transistor and a first power node, a reset transistor between the gain control transistor and a second power node, an amplification transistor connected to the floating diffusion node and a third power node, and a select transistor between the amplification transistor and a column line.

### CROSS-REFERENCE TO RELATED APPLICATION

This application claims benefit of priority to Korean Patent Application No. 10-2024-0109644 filed on Aug. 16, 2024 in the Korean Intellectual Property Office, the disclosure of which is incorporated herein by reference in its entirety.

### BACKGROUND

Embodiments of the present disclosure relate to an image sensor.

An image sensor may receive light and may generate an electric signal, and may include a pixel array having a plurality of pixels, and a peripheral circuit for driving a pixel array and generating an image. Each pixel may include a photodiode and a pixel circuit configured to convert charges generated by the photodiode into an electric signal, and the range of light intensity represented by an image sensor may be defined as dynamic range. The dynamic range may be effectively improved by including a plurality of photodiodes in a single pixel, but sensitivity of an image sensor may be reduced as an area of each pixel decreases to increase resolution. Accordingly, various methods to improve the dynamic range in a structure in which a single pixel includes a single photodiode has been suggested.

### SUMMARY

One or more embodiments provide an apparatus to improve dynamic range in an image sensor in which one pixel includes one photodiode.

According to an aspect of one or more embodiments, there is provided an image sensor, including a pixel array including a plurality of pixels, and a peripheral circuit connected to the plurality of pixels to drive the plurality of pixels, wherein each pixel of the plurality of pixels includes a photodiode and a pixel circuit configured to output a signal corresponding to electric charges generated by the photodiode, and wherein the pixel circuit includes a floating diffusion node configured to store the electric charges generated by the photodiode, a transfer transistor between the photodiode and the floating diffusion node, a gain control transistor connected to the floating diffusion node, a capacitor and a first switch transistor connected in series between the gain control transistor and a first power node, a reset transistor between the gain control transistor and a second power node, an amplification transistor including a gate connected to the floating diffusion node and connected to a third power node, and a select transistor between the amplification transistor and at least one column line of the plurality of column lines.

According to another aspect of one or more embodiments, there is provided an image sensor, including a plurality of pixels, and a peripheral circuit configured to obtain a pixel signal by driving the plurality of pixels, wherein each pixel of the plurality of pixels includes a photodiode and a pixel circuit connected to the photodiode, wherein the pixel circuit includes a transfer transistor between the photodiode and a floating diffusion node, a capacitor configured to store electric charges generated by the photodiode, a first switch transistor between the capacitor and a first power node, and a second switch transistor between the capacitor and a second power node, and wherein the first power node is in a first mesh pattern configured to supply a first power voltage, and the second power node is in a second mesh pattern configured to supply a second power voltage greater than the first power voltage, the second mesh pattern being electrically disconnected from the first mesh pattern.

According to yet another aspect of one or more embodiments, there is provided an image sensor, including a plurality of pixels, and a peripheral circuit configured to obtain pixel signals by driving the plurality of pixels, wherein each pixel of the plurality of pixels includes a photodiode and a pixel circuit connected to the photodiode, wherein the pixel circuit includes a transfer transistor between the photodiode and a floating diffusion node, a gain control transistor between the floating diffusion node and a first node, a capacitor between the first node and a second node, at least one switch transistor between the second node and a power node, a reset transistor connected to the first node, an amplification transistor including a gate connected to the floating diffusion node, and a select transistor between the amplification transistor and a column line.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a block diagram illustrating an image sensor according to one or more embodiments;

FIG. 2 is a diagram illustrating a pixel array structure of an image sensor according to one or more embodiments;

FIG. 3 is a diagram illustrating a structure of a pixel included in an image sensor according to one or more embodiments;

FIG. 4 is a diagram illustrating a pixel included in an image sensor according to one or more embodiments;

FIG. 5 is a diagram illustrating operations of an image sensor according to one or more embodiments;

FIGS. 6, 7, 8, 9, 10, 11, 12, and 13 are diagrams illustrating operations of an image sensor according to one or more embodiments;

FIGS. 14 and 15 are diagrams illustrating operations of an image sensor according to one or more embodiments;

FIGS. 16, 17, and 18 are diagrams illustrating operations of an image sensor according to one or more embodiments;

FIGS. 19, 20, and 21 are diagrams illustrating operations of an image sensor according to one or more embodiments;

FIGS. 22, 23, and 24 are diagrams illustrating operations of an image sensor according to one or more embodiments;

FIGS. 25, 26, and 27 are diagrams illustrating operations of an image sensor according to one or more embodiments;

FIGS. 28, 29, and 30 are diagrams illustrating operations of an image sensor according to one or more embodiments;

FIGS. 31, 32, and 33 are diagrams illustrating operations of an image sensor according to one or more embodiments;

FIGS. 34 and 35 are diagrams illustrating operations of an image sensor according to one or more embodiments; and

FIG. 36 is a diagram illustrating a pixel included in an image sensor according to one or more embodiments.

### DETAILED DESCRIPTION

Hereinafter, embodiments of the present disclosure will be described as follows with reference to the accompanying drawings. Embodiments described herein are example embodiments, and thus, the disclosure is not limited thereto.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

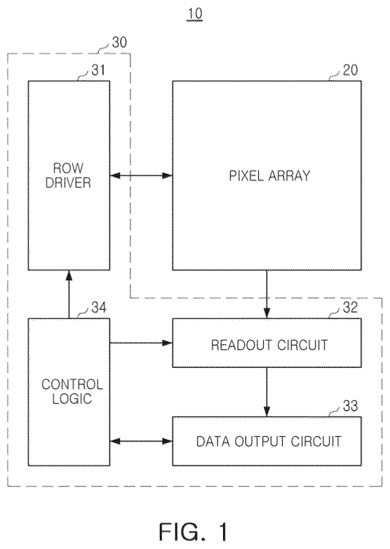

FIG. 1 is a block diagram illustrating an image sensor according to one or more embodiments.

Referring to FIG. 1, an image sensor 10 may include a pixel array 20 and a peripheral circuit 30.

The pixel array 20 may include a plurality of pixel regions arranged in an array form along a plurality of rows and a plurality of columns. Each of the plurality of pixel regions may include a photoelectric conversion element configured to generate an electric charge in response to light, and the photoelectric conversion element may be connected to a pixel circuit configured to generate and to output a signal corresponding to the electric charge generated by the photoelectric conversion element. A pixel may be implemented by a photoelectric conversion element and a pixel circuit. The photoelectric conversion element may include a photodiode formed of a semiconductor material, and/or an organic photodiode formed of an organic material.

For example, the pixel circuit may include a plurality of transistors and a capacitor. The capacitor may store electric charges excessively generated by the photodiode and may be connected to the photodiode through at least one transistor. In one or more embodiments, the capacitor may be configured as a metal-insulator-metal (MIM) capacitor.

The peripheral circuit 30 may include circuits for controlling the pixel array 20. For example, the peripheral circuit 30 may include a row driver 31, a readout circuit 32, a data output circuit 33, and a control logic 34. The row driver 31 may drive the pixel array 20 in unit of row (ROW) lines. For example, the row driver 31 may input control signals for controlling turning on/off of each transistor included in the pixel circuit to the pixel array 20 in unit of row line.

Among the pixels, pixels disposed in the same position in the row direction (the horizontal direction in FIG. 1) may share the same column line. For example, pixels disposed in the same position in the column (COLUMN) direction (the vertical direction in FIG. 1) may be simultaneously selected by the row driver 31 and may output pixel signals through the column lines. According to one or more embodiments, the readout circuit 32 may simultaneously receive signals from the pixels selected by the row driver 31 through the column lines. For example, the readout circuit 32 may receive a reset voltage and a signal voltage from each pixel in sequence, and the signal voltage may be configured by reflecting an electric charge generated by a photodiode of each pixel in a reset voltage

The readout circuit 32 may include a plurality of correlated dual samplers and a plurality of counters, and the correlated dual samplers may be connected to each other through the pixels and the column lines. For example, a correlated dual sampler and a counter may be connected to a column line. The correlated dual samplers may read voltage signals from pixels connected to a row line selected by the row line select signal of the row driver 31 through the column lines. One of the input terminals of each of the correlated dual samplers may be connected to column lines, and the other input terminal may receive a ramp voltage.

An output terminal of each of the correlated dual samplers may be connected to counters, and the counters may generate a digital pixel signal by counting the time period during which an output of each of the correlated dual samplers is maintained at a specific voltage. For example, the counter may count the time period during which the ramp voltage input to the correlated dual sampler is greater than a voltage of the column line and may convert the output of the correlated dual sampler into a digital pixel signal. The data output circuit 33 may include a memory such as a latch or a buffer circuit for temporarily storing a digital pixel signal.

The control logic 34 may include a timing controller for controlling operation timings of the row driver 31, the readout circuit 32, and the data output circuit 33. According to one or more embodiments, the control logic 34 may determine a data format output by the data output circuit 33, or may perform preprocessing of data to be output by the data output circuit 33.

In one or more embodiments, the readout circuit 32 may execute a readout operation for each of a plurality of pixels two or more times. For example, when one of a plurality of row lines is selected, the readout circuit 32 may read a signal corresponding to an electric charge generated by exposure of pixels, arranged along the selected row line, to light. In one or more embodiments, the readout circuit 32 may read a signal corresponding to an electric charge generated by pixels during a single exposure time period multiple times.

The readout circuit 32 may obtain signals from pixels under different operating conditions. For example, the readout circuit 32 may execute at least one readout operation under each of a condition in which a conversion gain of each pixel is relatively large and a condition in which a conversion gain of each pixel is relatively small. The conversion gain of each pixel may be varied depending on turning on/off of the transistor connected to the floating diffusion node of each of pixels.

As described above, each of the plurality of pixels may include a capacitor. During the exposure time period, an electric charge generated by the photodiode and exceeding a full well capacity (FWC) of the photodiode may be transferred to the capacitor and stored, and the readout circuit 32 may execute a readout operation of obtaining a signal corresponding to an electric charge stored in the capacitor. By generating an image using the signal obtained by the pixels under different operating conditions, the readout circuit 32 may expand a light intensity range which the image sensor 10 may represent, and may improve dynamic range.

Also, in one or more embodiments, in order to reduce dark signal non-uniformity (DSNU), an operation for controlling a bias voltage applied to the capacitor may be implemented by turning on/off the switch elements connected to the capacitor. Accordingly, a path through which the bias voltage applied to the capacitor is transmitted may be implemented as a mesh type wiring, and influence of resistance in the path through which the bias voltage is transmitted may be effectively reduced.

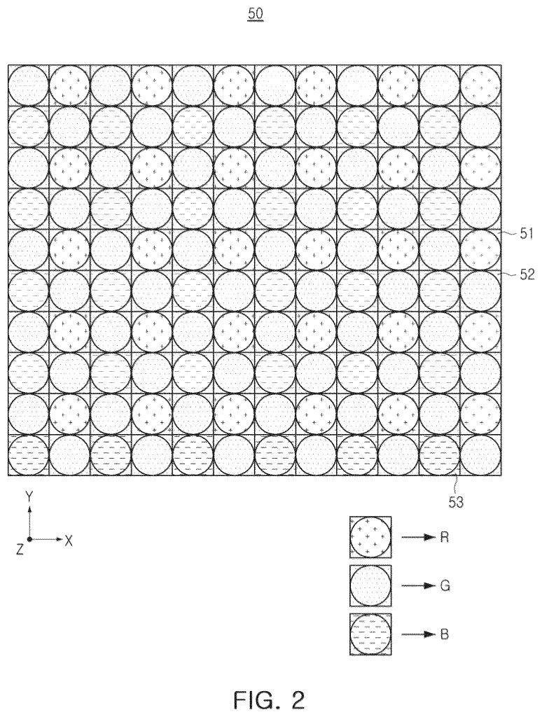

FIG. 2 is a diagram illustrating a pixel array structure of an image sensor according to one or more embodiments.

Referring to FIG. 2, a pixel array 50 of an image sensor according to one or more embodiments may include a plurality of pixels 51-53 arranged in the first direction (X-axis direction) and the second direction (Y-axis direction). For example, the pixel array 50 may include red pixels 51, green pixels 52, and blue pixels 53. Each of the red pixels 51 may include a red color filter, each of the green pixels 52 may include a green color filter, and each of the blue pixels 53 may include a blue color filter. In one or more embodiments illustrated in FIG. 2, each of the green pixels 52 may be adjacent to a portion of the red pixels 51 and a portion of the blue pixels 53 in the first direction and the second direction.

Each of the plurality of pixels 51-53 may include a photodiode. Accordingly, even when the number of pixels included in the pixel array 50 is increased to increase resolution of an image sensor, a light-receiving area of the photodiode in each of the plurality of pixels 51-53 may be maintained at a certain level, and degradation of sensitivity each of the plurality of pixels 51-53 may be reduced.

In a structure in which each of the plurality of pixels 51-53 includes a single photodiode, it may be difficult to maintain the dynamic range of the image sensor as compared to a structure in which each of the plurality of pixels 51-53 may include two or more photodiodes. In one or more embodiments, by configuring a pixel circuit connected to a photodiode in each of the plurality of pixels 51-53, a signal-to-noise ratio under each of a relatively high conversion gain condition and a relatively low conversion gain condition may be increased, thereby ensuring the dynamic range. Also, by reducing a resistive element of a transfer path of a bias voltage applied to a capacitor included in a pixel circuit, the DSNU of the image sensor may be addressed.

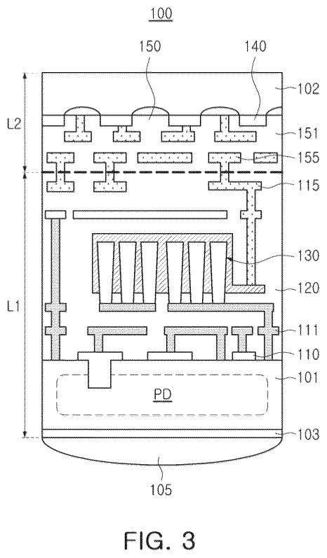

FIG. 3 is a diagram illustrating a structure of a pixel included in an image sensor according to one or more embodiments.

Referring to FIG. 3, an image sensor 100 according to one or more embodiments may have a structure in which a first layer L1 and a second layer L2 are stacked. The first layer L1 may include a first substrate 101, and a photodiode PD and a plurality of transistors 110 may be formed on the first substrate 101. The plurality of transistors 110 may be connected to each other by metal wirings 111 and may provide a pixel circuit connected to the photodiode PD.

The metal wirings 111 may be disposed in a first insulating layer 120 formed on a first surface of the first substrate 101 together with a capacitor 130. The capacitor 130 may be configured as a MIM capacitor and may be connected to a plurality of transistors 110 and may be included in the pixel circuit. The uppermost end wiring 115 disposed on an uppermost end of the first insulating layer 120 may be connected to an uppermost end wiring 155 of the second layer L2. A color filter 103 and a microlens 105 may be disposed on a second surface of the first substrate 101 opposite to the first surface of the first substrate 101.

The second layer L2 may include the second substrate 102, and a plurality of transistors 140 may be formed on the second substrate 102. The plurality of transistors 140 may be connected to each other by metal wirings 151 disposed in the second insulating layer 150, and may provide peripheral circuits for driving the pixel array, such as a row driver and a readout circuit. The uppermost end wiring 155 disposed on the uppermost end within the second insulating layer 150 may be connected to an uppermost end wiring 115 of the first layer L1.

However, the structure of the image sensor 100 according to one or more embodiments is not limited to the example illustrated in FIG. 3. For example, the capacitor 130 may be formed on a layer separate from the first layer L1. For example, the image sensor 100 may include a first layer L1 including a photodiode PD and a plurality of transistors 140, a second layer L2 in which a peripheral circuit is included, and a third layer disposed between the first layer L1 and the second layer L2 and including a capacitor 130.

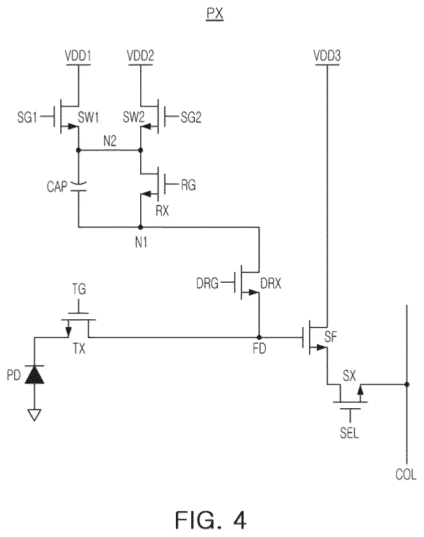

FIG. 4 is a diagram illustrating a pixel included in an image sensor according to one or more embodiments.

Referring to FIG. 4, a pixel PX according to one or more embodiments may include a photodiode PD and a pixel circuit. The pixel circuit may include a floating diffusion node FD, a transfer transistor TX, a gain control transistor DRX, a capacitor CAP, a first switch transistor SW1, a second switch transistor SW2, a reset transistor RX, an amplification transistor SF, and a select transistor SX. Control signals TG, RG, SG1, SG2, DRG, and SEL controlling the plurality of transistors included in the pixel circuit may be output by a row driver (e.g., the row driver 31 of FIG. 1).

The floating diffusion node FD may be connected to the photodiode PD through the transfer transistor TX, and when the transfer transistor TX is turned on by the transfer control signal TG, electric charges of the photodiode PD may be stored in the floating diffusion node FD. The gain control transistor DRX may be connected between the floating diffusion node FD and a first node N1. When the gain control transistor DRX is turned on by a gain control signal DRG, capacitance of the floating diffusion node FD may increase, such that a conversion gain of the pixel PX may decrease. Conversely, when the gain control transistor DRX is turned off, the conversion gain of the pixel PX may increase.

The first switch transistor SW1 and the capacitor CAP may be connected between the first node N1 and a first power node. The first power node may be configured to supply a first power voltage VDD1 and may be connected to a drain of the first switch transistor SW1. Between the first node N1 and the first power node, the first switch transistor SW1 and the capacitor CAP may be connected to each other in series.

The second switch transistor SW2 and the reset transistor RX may be connected between the first node N1 and a second power node. The second power node may be configured to supply a second power voltage VDD2 and may be connected to a drain of the second switch transistor SW2. In one or more embodiments, the second power voltage VDD2 may be the same as the first power voltage VDD1, or may be different from the first power voltage VDD1. In one or more embodiments, the second power voltage VDD2 may be greater than the first power voltage VDD1.

A node between the first switch transistor SW1 and the capacitor CAP may be connected to a node between the second switch transistor SW2 and the reset transistor RX and may be defined as a second node N2. The capacitor CAP and the reset transistor RX may be connected to each other in parallel between the first node N1 and the second node N2.

A gate of the amplification transistor SF may be connected to a floating diffusion node FD, and the amplification transistor SF may be connected between a third power node and a select transistor SX. The third power node may be configured to supply a third power voltage VDD3. In one or more embodiments, the third power voltage VDD3 may be equal to at least one of the first power voltage VDD1 and the second power voltage VDD2. In one or more embodiments, the third power voltage VDD3 may be equal to the second power voltage VDD2 and may be greater than the first power voltage VDD1. Also, in one or more embodiments, the third power voltage VDD3 may be greater than the first power voltage VDD1 and the second power voltage VDD2.

The amplification transistor SF may operate as a source-follower amplifier and may generate a signal by amplifying a voltage of the floating diffusion node FD. The signal generated by the amplification transistor SF may be output to the column line COL by a turning-on operation of the select transistor SX. The column line COL may be connected to one of the input terminals of the correlated dual sampler, and the correlated dual sampler may transmit a signal output to the column line COL and an output signal determined by a ramp voltage to the counter.

Operations of the pixel PX may include a shutter operation, an exposure operation, and a readout operation. In a shutter operation, electric charges of the floating diffusion node FD and the photodiode PD may be removed, and in an exposure operation, the photodiode PD may generate electric charges by being exposed to light for a predetermined exposure time. In a readout operation, a voltage of the floating diffusion node FD may be amplified and may be output to the column line COL, and for example, a reset voltage and a signal voltage may be output to the column line COL. The reset voltage may be output to the column line COL by the pixel circuit in a state in which the floating diffusion node FD is reset, and the signal voltage may be output to the column line COL by the pixel circuit in a state in which at least a portion of electric charges generated by the photodiode PD are stored in the floating diffusion node FD.

In one or more embodiments, the readout operation may be executed two or more times after a single exposure time. For example, the first readout operation and the second readout operation may be executed in sequence after a single exposure time. The first readout operation may be executed in a state in which the conversion gain of the pixel PX determined to be relatively high, and the second readout operation may be executed a state in which the conversion gain of the pixel PX determined to be low.

In one or more embodiments, a third readout operation may be further executed after the second readout operation. The third readout operation may be an operation of reading a signal voltage corresponding to electric charges generated by the photodiode PD by relatively strong light in the exposure operation and stored in the capacitor CAP. For example, electric charges generated beyond the FWC of the photodiode PD may move to the capacitor CAP by overflow and may be stored therein. In the third readout operation, in a state in which the gain control transistor DRX is turned on and electric charges stored in the capacitor CAP move to the floating diffusion node FD, the signal voltage may be output to the column line COL.

By executing two or more readout operations after the exposure time, the dynamic range of the image sensor may be improved. For example, the illuminance of the first range may be provided by the pixel signal obtained from the first readout operation, and the illuminance of the second range, greater than the first range, may be provided by the pixel signal obtained from the second readout operation. Also, by further executing a third readout operation, the illuminance of the third range, greater than the second range, may be provided. In one or more embodiments, by further executing a multiple exposure operation and a fourth readout operation after the third readout operation, the illuminance of the fourth range, greater than the third range, may be provided.

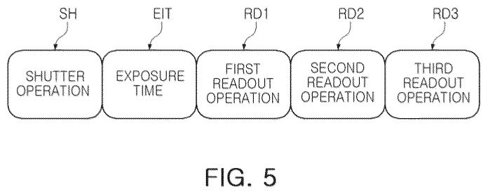

FIG. 5 is a diagram illustrating operations of an image sensor according to one or more embodiments.

FIG. 5 may be a diagram illustrating operations of a pixel included in an image sensor according to one or more embodiments. In one or more embodiments, pixels included in a pixel array may be arranged in a row direction and a column direction, may be connected to a row driver in the row direction, and may be connected to a readout circuit in the column direction. The row driver may simultaneously drive pixels arranged in the row direction, and accordingly, operations illustrated in FIG. 5 may be simultaneously executed in two or more pixels arranged in the row direction.

The pixel operations may include a shutter operation SH, an exposure time EIT, and a first readout operation RD1, a second readout operation RD2, and a third readout operation RD3. In the shutter operation SH, a reset operation for removing electric charges of a photodiode and a floating diffusion node may be executed. For example, in the shutter operation SH, the photodiode and the floating diffusion node may be electrically connected to a power node.

During an exposure time EIT, the photodiode may be exposed to light and may generate electric charges. For example, during the exposure time EIT, the transfer transistor may maintain a turned-off state, and the photodiode and the floating diffusion node may be electrically isolated and disconnected from each other. Accordingly, electric charges generated by the photodiode may not move to the floating diffusion node.

However, in an environment in which intensity of light entering the photodiode is relatively strong, electric charges exceeding the FWC of the photodiode may be generated. In this case, as a voltage of a node in which a photodiode is connected to a transfer transistor decreases due to the excessive electric charges generated by the photodiode, leakage through the transfer transistor may occur, and electric charges generated by the photodiode may move to the floating diffusion node.

In one or more embodiments, the pixel may be designed such that electric charges transferred from the photodiode to the floating diffusion node during the exposure time EIT may move to a capacitor connected to the floating diffusion node. For example, in an environment in which light intensity is extremely strong, electric charges generated by exceeding the FWC of the photodiode may pass through the floating diffusion node and may be stored in the capacitor. Thereafter, in at least one of the first to third readout operations, the pixel circuit may output a voltage corresponding to electric charges stored in the capacitor. Accordingly, even in an environment in which the illuminance is relatively high, the image may more accurately represent an object, and the dynamic range of the image sensor may be improved.

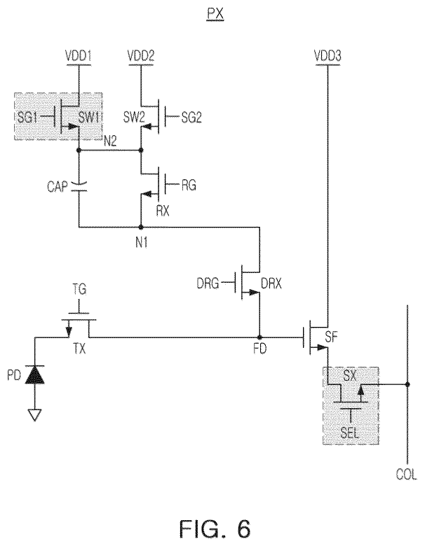

FIGS. 6 to 13 are diagrams illustrating operations of an image sensor according to one or more embodiments.

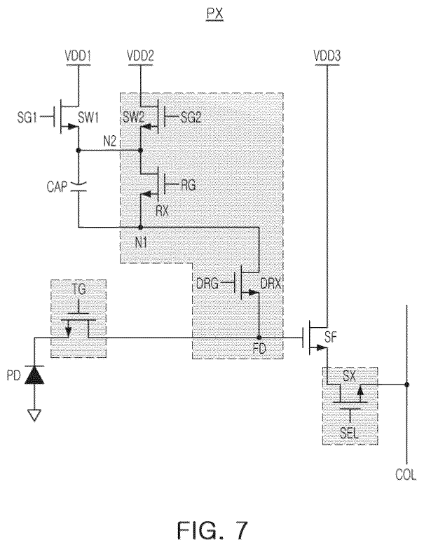

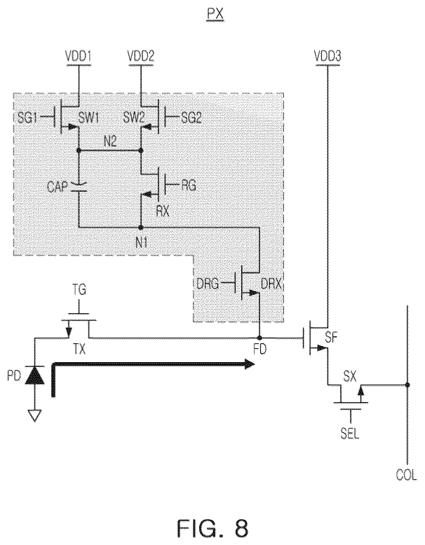

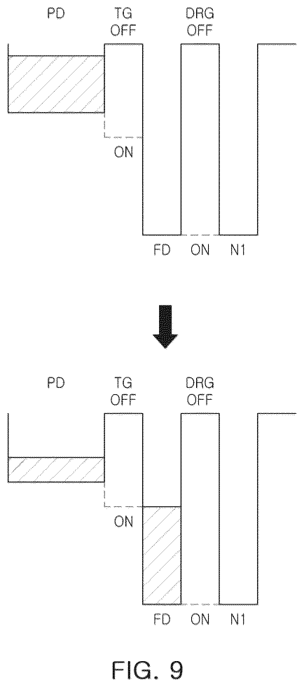

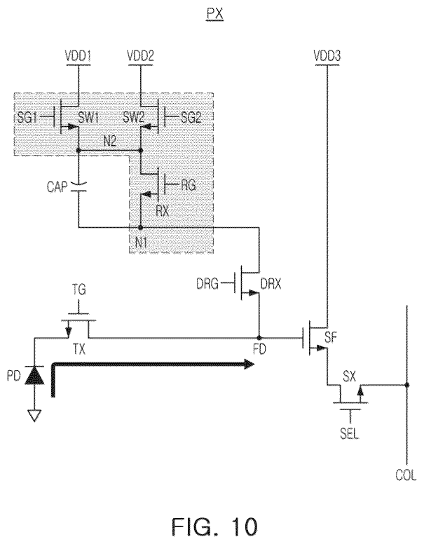

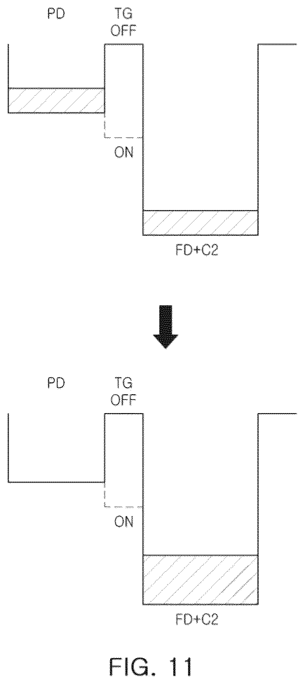

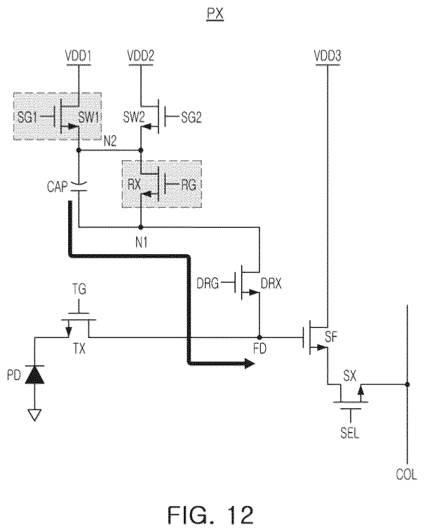

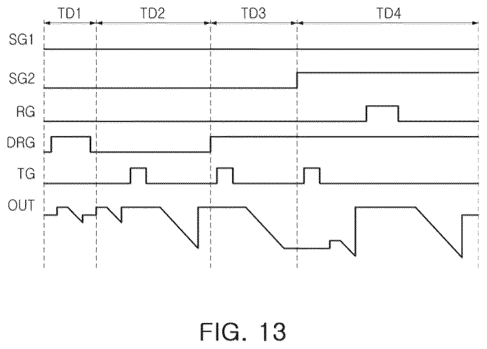

Each of the pixels PX included in the image sensor described with reference to FIGS. 6 to 13 may have the same structure as in the embodiment described with reference to FIG. 5 above. FIG. 6 may be a diagram illustrating a shutter operation of the pixel PX, and FIG. 7 may be a diagram illustrating operations of the pixel PX during an exposure time. FIGS. 8 and 9 may be diagrams illustrating a first readout operation of the pixel PX, FIGS. 10 and 11 may be diagrams illustrating a second readout operation of the pixel PX, and FIG. 12 may be a diagram illustrating a third readout operation of the pixel PX. FIG. 13 may be a timing diagram illustrating first to third readout operations.

In the operations of the pixel PX described with reference to FIGS. 6 to 13, the turning on/off of the transistors TX, RX, SW1, SW2, DRX, and X included in the pixel PX may be determined by a voltage of each of the control signals TG, RG, SG1, SG2, DRG, and SEL. For example, referring to FIG. 6 illustrating one or more embodiments of a shutter operation, the first switch control signal SG1 and the select control signal SEL may have voltages corresponding to a logic low, and the other control signals (TX, RG, SG2, DRG) may have voltages corresponding to a logic high. Accordingly, in the shutter operation, the first switch transistor SW1 and the select transistor SX may be turned off, and the other transistors may be turned on.

As illustrated in FIG. 6, the second switch transistor SW2, the reset transistor RX, the gain control transistor DRX, the transfer transistor TX may be turned on, and accordingly, the photodiode PD, the floating diffusion node FD, and the capacitor CAP may be connected to the second power node. By the second power voltage, electric charges of the photodiode PD, the floating diffusion node FD, and the capacitor CAP may be removed.

Referring to FIG. 7, during an exposure time, the first switch transistor SW1 may be turned on, and the other transistors SW2, RX, DRX, TX, and SX may be turned off. The photodiode PD may generate electric charges in response to light, and the generated electric charges may remain in the photodiode PD. However, in an environment in which relatively strong light is input, electric charges exceeding the FWC of the photodiode PD may be generated. Hereinafter, for ease of description, electric charges generated by exceeding the FWC of the photodiode PD may be defined as excessive electric charges.

When electric charges are generated by exceeding the FWC at the photodiode PD, a voltage of a node in which the transfer transistor TX and the photodiode PD are connected to each other, for example, a voltage of source of the transfer transistor TX may decrease due to the electric charges. Accordingly, even though a transfer control signal TG input to a gate of the transfer transistor TX is maintained at a voltage corresponding to a logic low, a path for moving electric charges may be formed through a channel of the transfer transistor TX, and electric charges generated by exceeding the FWC of the photodiode PD may move from the photodiode PD to the floating diffusion node FD.

The decrease in a source voltage of the transistor due to electric charges generated by exceeding the FWC of the photodiode PD may also occur in the gain control transistor DRX. Accordingly, at least a portion of the excessive electric charges moving to the floating diffusion node FD may be stored in the capacitor CAP. The first switch transistor SW1 connected to the capacitor CAP may be turned on during the exposure time such that excessive electric charges moving to the floating diffusion node FD may move to the capacitor CAP. Accordingly, the first power voltage VDD1 may be applied to the capacitor CAP during the exposure time.

Thereafter, the first readout operation will be described with reference to FIGS. 8 and 9. The first readout operation may be a readout operation executed under determined conditions such that the pixel PX may have a relatively high conversion gain. However, in one or more embodiments, an operation of resetting the floating diffusion node FD may be executed after the exposure time has ended, before the first readout operation is executed.

When the exposure time ends, the row driver may turn on the select transistor SX, and the reset voltage may be output through the column line COL connected to the readout circuit. When the reset voltage is output, the transfer transistor TX may be turned on as illustrated in FIG. 8, and the electric charges generated by the photodiode PD during the exposure time may move to the floating diffusion node FD. The amplification transistor SF may output a signal voltage amplifying a voltage of the floating diffusion node FD to the column line COL. The readout circuit connected to the column line COL may derive the first pixel signal from a difference between the reset voltage and the signal voltage. The first pixel signal may be a signal for covering the relatively low first range illuminance.

Referring to FIG. 8 and FIG. 9, the gain control transistor DRX connected to the floating diffusion node FD may be maintained in a turned-off state such that the pixel PX may have a relatively high conversion gain while the first readout operation is executed. Accordingly, capacitance of the floating diffusion node FD may be maintained to be lower than a certain value and the pixel PX may have a relatively high conversion gain.

Referring to FIG. 9, the transfer transistor TX may be turned on by the transfer control signal TG, such that a portion of electric charges of the photodiode PD may move to the floating diffusion node FD. While the first readout operation is executed, the gain control transistor DRX may be turned off, and the first node N1 and the floating diffusion node FD may be electrically isolated and disconnected from each other, such that electric charges may be stored in the floating diffusion node FD having a relatively low capacitance, and the reset voltage and the signal voltage may be output to the column line COL under a relatively high conversion gain condition.

Thereafter, the second readout operation will be described with reference to FIGS. 10 and 11. The second readout operation may be configured to be executed under a determined condition such that the pixel PX may have a relatively low conversion gain. Referring to FIG. 10, while the second readout operation is executed, the gain control transistor DRX may be turned on, and the capacitor CAP may be electrically connected to the floating diffusion node FD.

Since the capacitor CAP is connected to the floating diffusion node FD, capacitance of the floating diffusion node FD may increase as compared to the first readout operation, and accordingly, a conversion gain of the pixel PX may decrease. However, one of the electrodes of the capacitor CAP may be electrically connected to the floating diffusion node FD through the first node N1, and the other may be floated at the second node N2. When capacitance of the capacitor CAP is defined as a first capacitance C1, and capacitance of the floating second node N2 is defined as a second capacitance C2, capacitance Cadd added to the floating diffusion node FD may be represented as in Equation 1 below.

$$Cadd = \frac{C 1 + C 2}{C 1 * C 2} ≅ C 2 \qquad [ Equation 1 ]$$

The first capacitance C1 of the capacitor CAP may be relatively greater than the second capacitance C2 present in the floating second node N2. Accordingly, the capacitance Cadd added to the floating diffusion node FD may be the second capacitance C2 present in the floating second node N2. Accordingly, by adding a capacitance relatively smaller than capacitance C1 of the capacitor CAP to the floating diffusion node FD while the second readout operation is executed, a signal-to-noise ratio of the image sensor may be improved.

In a state in which the gain control transistor DRX is turned on and capacitance of the floating diffusion node FD increases, the transfer transistor TX may be turned on and residual electric charges remaining in the photodiode PD may move to the floating diffusion node FD. Referring to FIG. 11, the residual electric charges not transferred to the floating diffusion node FD in the first readout operation and remained in the photodiode PD may move to the floating diffusion node FD as the transfer transistor TX is turned on in the second readout operation. As illustrated in FIG. 11, capacitance of the floating diffusion node FD may be obtained by adding the second capacitance C2, described above, to the capacitance of the floating diffusion node FD. As such, the signal voltage may be output to the column line COL in the second readout operation under the condition in which the pixel PX has a relatively low conversion gain.

Since at least a portion of electric charges of the photodiode PD have already moved to the floating diffusion node FD in the first readout operation, the reset voltage may not be output before the signal voltage in the second readout operation. In one or more embodiments, before the first readout operation starts after the exposure time as described above, the gain control transistor DRX may be turned on and may lower the conversion gain of the pixel PX, and the pixel PX may output a reset voltage through the column line COL. The readout circuit may produce a second pixel signal under a relatively low conversion gain condition using a difference between the signal voltage obtained in the second readout operation and the reset voltage. The second pixel signal may be for covering illuminance of the second range greater than the first range.

FIG. 12 may be a diagram illustrating a third readout operation. Referring to FIG. 12, in the third readout operation, the second switch transistor SW2 and the gain control transistor DRX may be turned on. As the second switch transistor SW2 and the gain control transistor DRX are turned on, electric charges stored in the capacitor CAP may move to the floating diffusion node FD as illustrated in FIG. 12. A signal voltage corresponding to electric charges stored in the capacitor CAP may be output through the column line COL.

When the signal voltage is output, the row driver may turn off the transfer transistor TX and may turn on the reset transistor RX. Accordingly, a reset operation in which electric charges of the capacitor CAP and electric charges of the floating diffusion node FD are removed may be executed, and the reset voltage may be output through the column line COL. In the third readout operation, the signal voltage may be output prior to the reset voltage. The readout circuit may generate a third pixel signal using a difference between the reset voltage and the signal voltage output by the pixel PX in the third readout operation. The third pixel signal may be for covering illuminance of the third range greater than the second range.

As described above, electric charges generated by exceeding the FWC at the photodiode PD during the exposure time may be stored in the capacitor CAP. Under the condition in which light strong enough to generate electric charges exceeding the FWC of the photodiode PD is incident to the pixel PX, electric charges may be stored in the capacitor CAP. Accordingly, by using the third pixel signal generated by the electric charges stored in the capacitor CAP, relatively high illuminance which may be difficult to be provided with the second pixel signal may be provided.

FIG. 13 may be a timing diagram illustrating a readout operation after the exposure time. Referring to FIG. 13, during the first time period TD1 after the exposure time, the gain control transistor DRX may be turned on by the gain control signal DRG, and the conversion gain of the pixel PX may be reduced. During the first time period TD1, the output signal OUT which the pixel PX sends out through the column line COL may be a reset voltage, and the reset voltage output in the first time period TD1 may be a reset voltage under a relatively low conversion gain condition.

During the second time period TD2 after the first time period TD1, the first readout operation may be executed. During the second time period TD2, the gain control transistor DRX may be turned off by the gain control signal DRG. Also, the first switch transistor SW1, the second switch transistor SW2, and the reset transistor RX may also be turned off. Accordingly, capacitance of the floating diffusion node FD may be maintained at a small value, and the conversion gain of the pixel PX may increase.

In the second time period TD2, the output signal OUT which the pixel PX outputs to the column line COL before the transfer transistor TX is turned on may be a reset voltage. Also, after the transfer transistor TX is turned on and at least a portion of electric charges of the photodiode PD are transferred to the floating diffusion node, the pixel PX may output a signal voltage to the column line COL. The readout circuit may generate a first pixel signal corresponding to a difference between the pixel voltage and the signal voltage which the pixel PX outputs during the second time period TD2. The first pixel signal may be generated under a relatively high conversion gain condition, and may be for covering a relatively low illuminance range.

In the third time period TD3, the gain control transistor DRX may be turned on, and the conversion gain of the pixel PX may be reduced, and the second readout operation may be executed in a state in which the conversion gain is reduced. When the transfer transistor TX is turned on by the transfer control signal TG, electric charges not moving to the floating diffusion node FD and remaining in the photodiode PD during the second time period TD2 may move to the floating diffusion node FD. However, embodiments are not limited thereto, and electric charges of the photodiode PD may move to the floating diffusion node FD during the second time period TD2.

The pixel PX may output a signal voltage through the column line COL at a time point after the transfer transistor TX is turned on. During the third time period TD3, the pixel PX may generate a signal voltage under a relatively low conversion gain condition and may output the voltage to the column line COL. In one or more embodiments, the readout circuit may generate a second pixel signal corresponding to a difference between the reset voltage output by the pixel PX during the first time period TD1 and the signal voltage output by the pixel PX during the third time period TD3. The second pixel signal may be a signal for covering a relatively high illuminance range as compared to the first pixel signal.

During the fourth time period TD4, a third readout operation may be executed. Upon entering the fourth time period TD4, the gain control transistor DRX and the second switch transistor SW2 may be turned on, and accordingly, electric charges of the capacitor CAP may move to the floating diffusion node FD. Also, the transfer transistor TX may be turned on, such that electric charges remaining in the photodiode PD may move to the floating diffusion node FD. The pixel PX may output a signal voltage through the column line COL.

When the signal voltage is output, the reset transistor RX may be turned on by the row driver. Accordingly, the floating diffusion node FD and the capacitor CAP may be reset, and the pixel PX may output a reset voltage to the column line COL after the reset transistor RX is turned off. The readout circuit may generate a third pixel signal using a difference between the reset voltage output by the pixel PX during the fourth time period TD4 and the signal voltage. The third pixel signal may be for covering a relatively high illuminance range as compared to the first pixel signal and the second pixel signal.

As described with reference to FIGS. 6 to 13, in one or more embodiments, a readout operation may be executed two or more times after a single exposure time. A first pixel signal covering a relatively low illuminance range may be obtained by the readout circuit executing a first readout operation under a condition in which the pixel PX has a relatively high conversion gain. Also, a second pixel signal covering a relatively high illuminance range may be obtained by the readout circuit executing a second readout operation under a condition in which the pixel PX has a relatively low conversion gain. Also, electric charges generated by exceeding the FWC of the photodiode PD during the exposure time may be stored in the capacitor CAP, and a third pixel signal corresponding to the electric charges stored in the capacitor CAP may be obtained by the readout circuit in the third readout operation. Accordingly, an relatively high illuminance range which may be difficult to be provided with the second pixel signal may be provided with the third pixel signal, and the dynamic range of the image sensor may be improved.

In one or more embodiments, in an operation of changing the conversion gain of the pixel PX, the gain control transistor DRX connected between the floating diffusion node FD and the first node N1 may be turned on or off. By turning off the gain control transistor DRX under a relatively high conversion gain condition, capacitance of the floating diffusion node FD may be determined to a value lower than a certain value, and a signal-to-noise ratio in the relatively low illuminance region may be improved.

The capacitor CAP may be configured as a MIM capacitor including a first electrode, a second electrode, and a dielectric layer therebetween. When the first electrode is configured as an electrode connected to the first node N1 and the second electrode is configured as an electrode connected to the second node N2, the first electrode may be directly connected to an active region for implementing the gain control transistor DRX, such as an active region providing a drain by a metal contact. In the region in which the metal contact and the active region are in contact with each other, current leakage may occur due to deterioration of properties. The leakage current may degrade dark signal non-uniformity (DSNU) properties of the image sensor, and to compensate for the degradation, the voltage applied to the second electrode of the capacitor CAP during the exposure time when electric charges are generated may be reduced.

As described above with reference to FIGS. 6 and 7, in the shutter operation in which electric charges of the capacitor CAP are removed, the second electrode first power voltage VDD1 of the capacitor CAP may be applied, and during the exposure time when electric charges move to the capacitor CAP, the second power voltage VDD2 of the second electrode of the capacitor CAP may be applied. Also, in the third readout operation in which the pixel PX outputs a signal voltage corresponding to electric charges stored in the capacitor CAP, the first power voltage VDD1 may be applied again to the second electrode of the capacitor CAP.

In one or more embodiments, the second electrode of the capacitor CAP may supply the first power voltage VDD1 through the first switch transistor SW1 and may be connected to a first mesh pattern defined as the first power node. Also, the second electrode of the capacitor CAP may supply the second power voltage VDD2 through the second switch transistor SW2 and may be connected to the second mesh pattern defined as the second power node. The peripheral circuit of the image sensor may change a voltage applied to the second electrode of the capacitor CAP as described above by turning on/off the first switch transistor SW1 connected to the first power node and the second switch transistor SW2 connected to the second power node, respectively.

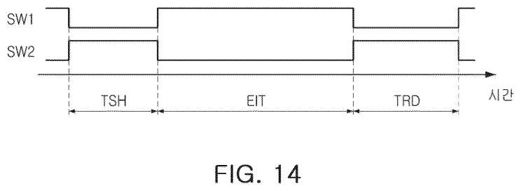

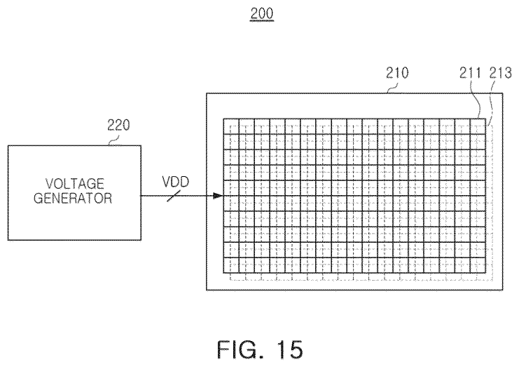

According to one or more embodiments, instead of connecting the metal wiring to the second electrode of the capacitor CAP and changing the voltage applied to the metal wiring, the voltage applied to the second electrode of the capacitor may be controlled by selecting the turning on/off of the first and second switch transistors SW1 and SW2, respectively. Accordingly, influence of resistance of the metal wiring may be reduced, thereby improving noise properties and effectively improving DSNU, which will be described in greater detail with reference to FIGS. 14 and 15.

FIGS. 14 and 15 are diagrams illustrating operations of an image sensor according to one or more embodiments.

FIG. 14 may be a diagram illustrating turning on/off operations of the first switch transistor SW1 and the second switch transistor SW2 in the pixel PX according to the embodiment described with reference to FIG. 4 above. FIG. 14 may be a timing diagram illustrating the first switch control signal SG1 and the second switch control signal SG2 controlling operations of the first switch transistor SW1 and the second transistor SW2 during each of the shutter operation time TSH, the exposure time EIT, and the readout operation time TRD.

Referring to FIG. 14, the first switch transistor SW1 may be turned off and the second switch transistor SW2 may be turned on during the shutter operation time TSH. Accordingly, a relatively large second power voltage VDD2 may be applied to a second electrode of the capacitor CAP. As described above, the first electrode of the capacitor CAP may be configured to be directly connected to an active region of the gain control transistor DRX by a metal contact, and a dielectric layer may be disposed between the first electrode and the second electrode.

During the exposure time EIT, the first switch transistor SW1 may be turned on and the second switch transistor SW2 may be turned off. Accordingly, a relatively small first power voltage VDD1 may be applied to the second electrode of the capacitor CAP, which may reduce leakage current caused by damage due to contact between the metal contact and the active region. During the readout operation time TRD, the first switch transistor SW1 may be turned off again and the second switch transistor SW2 may be turned on, such that the second power voltage VDD2 may be applied to the second electrode of the capacitor CAP. The readout operation time TRD may be the time period for which the pixel PX outputs a signal voltage corresponding to electric charges stored in the capacitor CAP.

FIG. 15 may be a diagram illustrating an image sensor 200 according to one or more embodiments. Referring to FIG. 15, the image sensor 200 according to one or more embodiments may include a pixel array 210 and a voltage generator 220. The voltage generator 220 may generate and output a plurality of power voltages VDD, and the power voltages VDD may be input to a first mesh pattern 211 and a second mesh pattern 213 each of which is formed by a plurality of row lines and column lines corresponding to the pixel array 210.

The power voltages VDD may include a first power voltage VDD1 and a second power voltage VDD2, and the first power voltage VDD1 may be input to the first mesh pattern 211 and the second power voltage VDD2 may be input to the second mesh pattern 213. The first mesh pattern 211 may be connected to the first switch transistor SW1 included in each pixel of the pixel array 210, and the second mesh pattern 213 may be connected to the second switch transistor SW2 included in each pixel.

As described above, in one or more embodiments, the voltage applied to the second electrode of the capacitor CAP may be controlled by controlling the turning on/off of each of the first switch transistor SW1 and the second switch transistor SW2. The voltage applied to the second electrode of the capacitor CAP may be stably supplied through the first mesh pattern 211 or the second mesh pattern 213, and the DSNU of the image sensor 200 may be effectively improved.

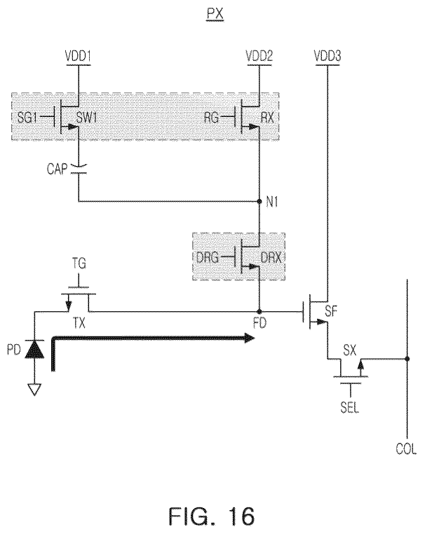

FIGS. 16 to 18 are diagrams illustrating operations of an image sensor according to one or more embodiments.

An image sensor according to one or more embodiments described with reference to FIGS. 16 to 18 may include a pixel PX configured differently from the image sensor according to the embodiment described with reference to FIG. 4. Referring to FIGS. 16 to 18, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a reset transistor RX, an amplification transistor SF, and a select transistor SX. Control signals TG, RG, SG1, DRG, and SEL controlling a plurality of transistors included in the pixel circuit may be output by a row driver.

As compared to the embodiment illustrated in FIG. 4, a pixel PX according to one or more embodiments described with reference to FIGS. 16 to 18 may not include a second switch transistor SW2, and only a reset transistor RX may be connected between the first node N1 and the second power node. The first electrode of the capacitor CAP may be connected to the first node N1, and the second electrode of the capacitor CAP may be connected to the first power node configured to supply the first power voltage VDD1 through the first switch transistor SW1. Accordingly, the voltage supplied to the second electrode of the capacitor CAP may be adjusted by increasing/decreasing the first power voltage VDD1.

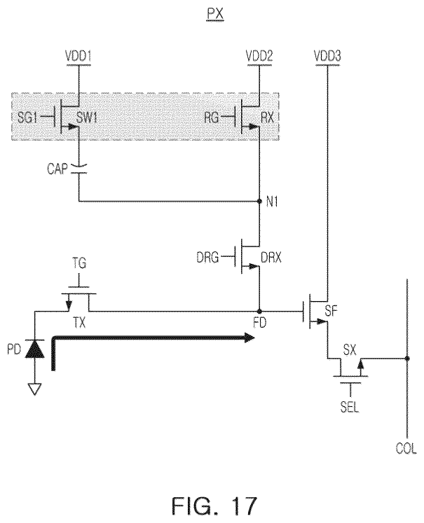

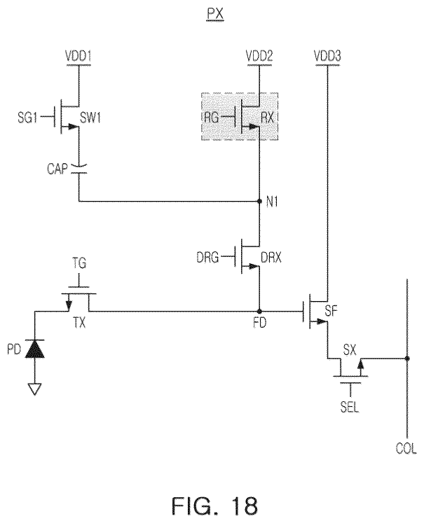

FIGS. 16 to 18 may be diagrams illustrating first to third readout operations, respectively. FIG. 16 may be a diagram illustrating a first readout operation in which a pixel PX outputs a signal under a relatively high conversion gain condition, and FIG. 17 may be a diagram illustrating a second readout operation in which a pixel PX outputs a signal under a relatively low conversion gain condition. FIG. 18 may be a diagram illustrating a third readout operation in which a signal corresponding to electric charges generated by exceeding the FWC of a photodiode PD during the exposure time and stored in a capacitor CAP is output.

Referring to FIG. 16, in the first readout operation, the first switch transistor SW1, the reset transistor RX, and the gain control transistor DRX may be turned off. Accordingly, capacitance of the floating diffusion node FD may be determined to be relatively low, and the conversion gain of the pixel PX may be increased. While the transfer transistor TX is turned off, the pixel PX may output a reset voltage through the column line COL. Thereafter, the transfer transistor TX may be turned on, and at least a portion of electric charges of the photodiode PD may be transferred to the floating diffusion node FD, and the pixel may output the signal voltage to the column line COL.

Thereafter, referring to FIG. 17, in the second readout operation, the gain control transistor DRX may be turned on. Accordingly, capacitance of the floating diffusion node FD may be determined to be relatively high, and the conversion gain of the pixel PX may be reduced. In the second readout operation, the pixel PX may output the signal voltage through the column line COL after the transfer transistor TX is turned on, and electric charges remaining in the photodiode PD may be transferred to the floating diffusion node FD. The reset voltage under the relatively low conversion gain condition may be output by the pixel PX before the exposure time ends and the first readout operation starts as described above with reference to FIG. 13.

Referring to FIG. 18, in the third readout operation, the gain control transistor DRX and the first switch transistor SW1 may be turned on. Accordingly, electric charges generated by exceeding the FWC of the photodiode PD during the exposure time and stored in the capacitor CAP may move to the floating diffusion node FD. In the third readout operation, the pixel PX may output the signal voltage after the transfer transistor TX is turned on. When the signal voltage is output, the reset transistor RX may be turned on by the row driver and electric charges of the floating diffusion node FD may be removed. When the electric charges of the floating diffusion node FD are removed, the pixel PX may output the reset voltage to the column line COL.

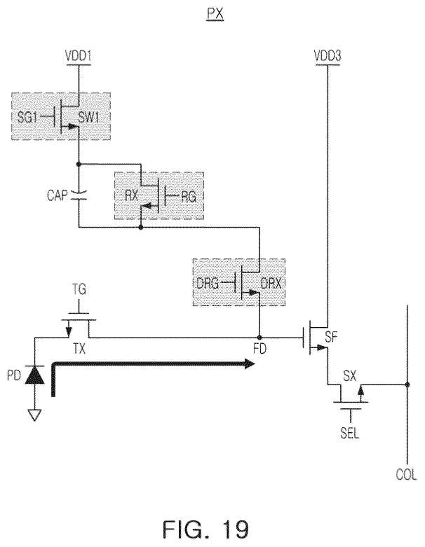

FIGS. 19 to 21 are diagrams illustrating operations of an image sensor according to one or more embodiments.

Referring to FIGS. 19 to 21, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a reset transistor RX, an amplification transistor SF, and a select transistor SX. Control signals TG, RG, SG1, DRG, and SEL controlling a plurality of transistors included in the pixel circuit may be output by a row driver.

As compared to the embodiment illustrated in FIG. 4, a pixel PX according to one or more embodiments described with reference to FIGS. 19 to 21 may not include a second switch transistor SW2. The reset transistor RX may be connected to the capacitor CAP in parallel.

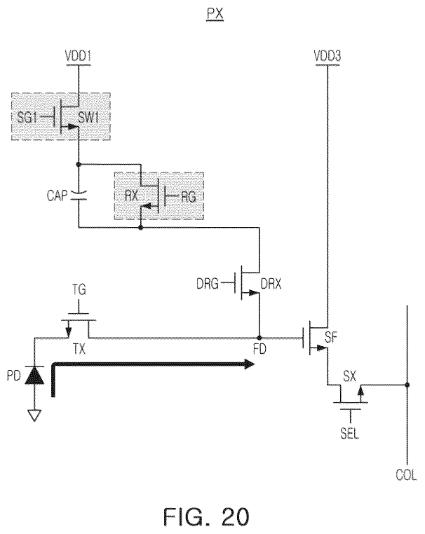

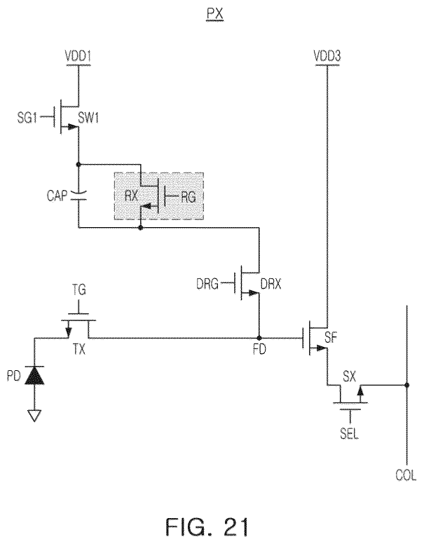

FIGS. 19 to 21 may be diagrams illustrating first to third readout operations, respectively. FIG. 19 may be a diagram illustrating a first readout operation in which a pixel PX outputs a signal under a relatively high conversion gain condition, and FIG. 20 may be a diagram illustrating a second readout operation in which a pixel PX outputs a signal under a relatively low conversion gain condition. FIG. 21 may be a diagram illustrating a third readout operation in which a signal corresponding to electric charges generated by exceeding the FWC of a photodiode PD during the exposure time and stored in a capacitor CAP is output.

Referring to FIG. 19, in the first readout operation, the first switch transistor SW1, the reset transistor RX, and the gain control transistor DRX may be turned off. Accordingly, capacitance of the floating diffusion node FD may be determined to be low, and the conversion gain of the pixel PX may be increased. In a state in which the transfer transistor TX is turned off, the pixel PX may output the reset voltage through the column line COL. Thereafter, the transfer transistor TX may be turned on, and at least a portion of electric charges of the photodiode PD may be transferred to the floating diffusion node FD, and the pixel may output the signal voltage to the column line COL.

Thereafter, referring to FIG. 20, in the second readout operation, the gain control transistor DRX may be turned on. Accordingly, capacitance of the floating diffusion node FD may be determined to be relatively high, and a conversion gain of the pixel PX may be reduced. In the second readout operation, the pixel PX may output the signal voltage through the column line COL after the transfer transistor TX is turned on, and electric charges remaining in the photodiode PD may be transferred to the floating diffusion node FD. The reset voltage under the relatively low conversion gain condition may be output by the pixel PX before the exposure time ends and the first readout operation starts as described above with reference to FIG. 13.

Referring to FIG. 21, in the third readout operation, the gain control transistor DRX and the first switch transistor SW1 may be turned on. Accordingly, electric charges generated by exceeding the FWC of the photodiode PD during the exposure time and stored in the capacitor CAP may move to the floating diffusion node FD. In the third readout operation, the pixel PX may output the signal voltage after the transfer transistor TX is turned on. When the signal voltage is output, the reset transistor RX may be turned on by the row driver and electric charges of the floating diffusion node FD may be removed. When electric charges of the floating diffusion node FD are removed, the pixel PX may output the reset voltage to the column line COL.

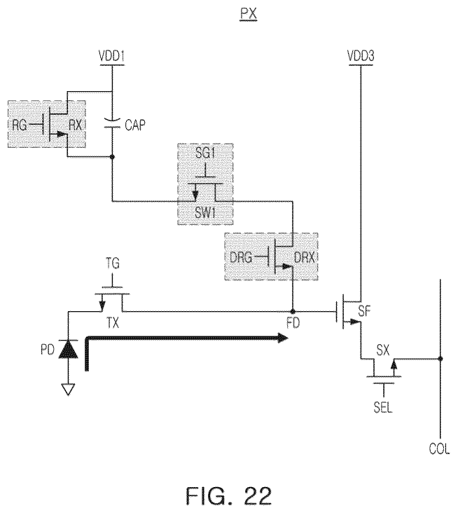

FIGS. 22 to 24 are diagrams illustrating operations of an image sensor according to one or more embodiments.

Referring to FIGS. 22 to 24, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a reset transistor RX, an amplification transistor SF, and a select transistor SX. A plurality of transistors included in the pixel circuit may be controlled by control signals TG, RG, SG1, DRG, and SEL output by the row driver.

As compared to the embodiment illustrated in FIG. 4, a pixel PX according to one or more embodiments described with reference to FIGS. 22 to 24 may not include a second switch transistor SW2, and the reset transistor RX may be connected to the first power node instead of the second power node. Also, the first switch transistor SW1 may be connected between the capacitor CAP and the gain control transistor DRX. The first electrode of the capacitor CAP may be connected to the first switch transistor SW1, and the second electrode of the capacitor CAP may be connected to the first power node supplying the first power voltage VDD1. Accordingly, the voltage supplied to the second electrode of the capacitor CAP may be adjusted by increasing/decreasing the first power voltage VDD1. The reset transistor RX may be connected to the capacitor CAP in parallel.

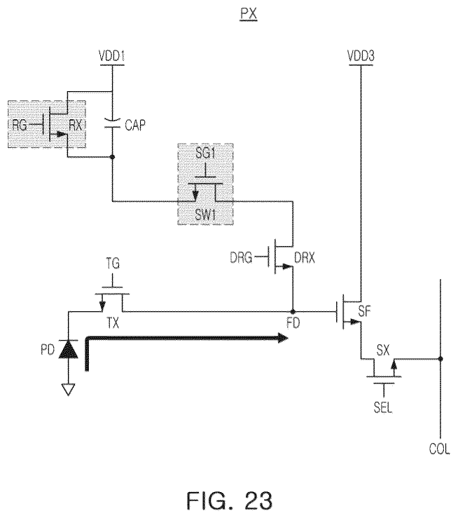

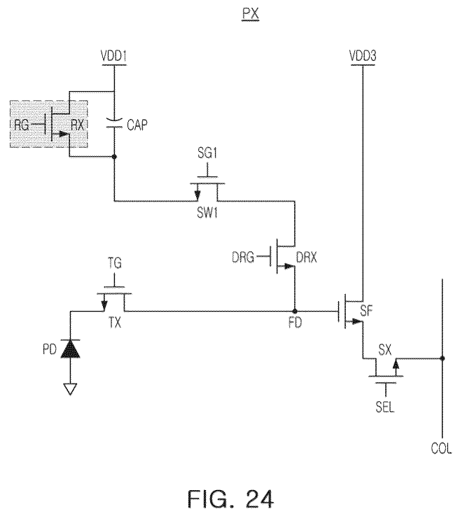

FIGS. 22 to 24 may be diagrams illustrating first to third readout operations, respectively. FIG. 22 may be a diagram illustrating a first readout operation in which a pixel PX outputs a signal under a relatively high conversion gain condition, and FIG. 23 may be a diagram illustrating a second readout operation in which a pixel PX outputs a signal under a relatively low conversion gain condition. FIG. 24 may be a diagram illustrating a third readout operation in which a signal corresponding to electric charges generated by exceeding the FWC of the photodiode PD during the exposure time and stored in the capacitor CAP is output.

Referring to FIG. 22, in the first readout operation, the first switch transistor SW1, the reset transistor RX, and the gain control transistor DRX may be turned off. Accordingly, capacitance of the floating diffusion node FD may be determined to be relatively low, and the conversion gain of the pixel PX may be increased. In a state in which the transfer transistor TX turned off, the pixel PX may output the reset voltage through the column line COL, and thereafter, in a state in which the transfer transistor TX is turned on, and at least a portion of the electric charges of the photodiode PD are transferred to the floating diffusion node FD, the signal voltage may be output to the column line COL.

Thereafter, referring to FIG. 23, in the second readout operation, the gain control transistor DRX may be turned on. Accordingly, capacitance of the floating diffusion node FD may be determined to be relatively high, and the conversion gain of the pixel PX may be decreased. In the second readout operation, after the transfer transistor TX is turned on and electric charges remaining in the photodiode PD move to the floating diffusion node FD, the pixel PX may output the signal voltage through the column line COL. The reset voltage under the relatively low conversion gain condition may be output by the pixel PX before the exposure time ends and the first readout operation starts, as described above with reference to FIG. 13.

Referring to FIG. 24, in the third readout operation, the gain control transistor DRX and the first switch transistor SW1 may be turned on. Accordingly, electric charges generated by exceeding the FWC of the photodiode PD during the exposure time and stored in the capacitor CAP may move to the floating diffusion node FD. In the third readout operation, the pixel PX may output the signal voltage after the transfer transistor TX is turned on. When the signal voltage is output, the reset transistor RX may be turned on by the row driver and electric charges of the floating diffusion node FD may be removed. When electric charges of the floating diffusion node FD are removed, the pixel PX may output a reset voltage to the column line COL.

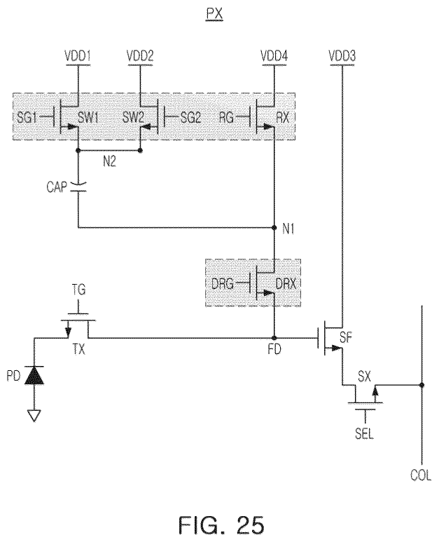

FIGS. 25 to 27 are diagrams illustrating operations of an image sensor according to one or more embodiments.

Referring to FIGS. 25 to 27, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a second switch transistor SW2, a reset transistor RX, an amplification transistor SF, and a select transistor SX. The plurality of transistors included in the pixel circuit may be controlled by control signals TG, RG, SG1, SG2, DRG, and SEL output by the row driver.

In a pixel PX according to one or more embodiments described with reference to FIGS. 25 to 27, the reset transistor RX may not be connected between the first node N1 and the second node N2. The reset transistor RX may be connected between the fourth power node supplying the fourth power voltage VDD4 and the first node N1. The first switch transistor SW1 and the second switch transistor SW2 may be connected to the second node N2 to which the capacitor CAP is connected. During the time for executing the shutter operation and the readout operation of the pixel PX, the second switch transistor SW2 may be turned on such that a relatively large second power voltage VDD2 may be applied to the capacitor CAP, and during the exposure time of the pixel PX, the first switch transistor SW1 may be turned on such that a relatively small first power voltage VDD1 may be applied to the capacitor CAP.

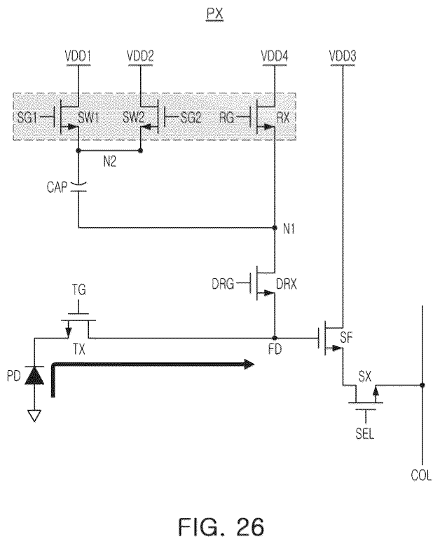

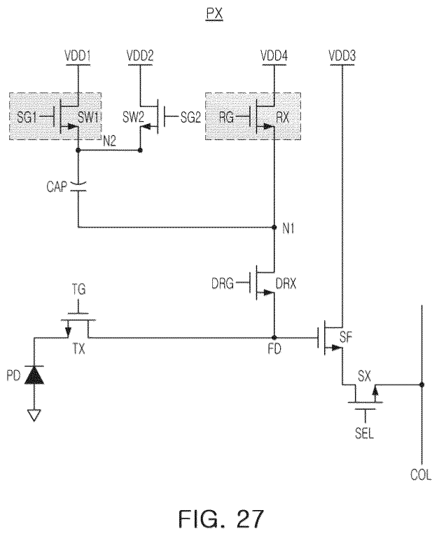

FIGS. 25 to 27 may be diagrams illustrating the first to third readout operations, respectively. FIG. 25 may be a diagram illustrating the first readout operation in which the pixel PX outputs a signal under a relatively high conversion gain condition, and FIG. 26 may be a diagram illustrating the second readout operation in which the pixel PX outputs a signal under a relatively low conversion gain condition. FIG. 27 may be a diagram illustrating the third readout operation in which a signal corresponding to electric charges generated by exceeding the FWC of the photodiode PD during the exposure time and stored in the capacitor CAP is output.

Referring to FIG. 25, in the first readout operation, the first switch transistor SW1, the second switch transistor SW2, the reset transistor RX, and the gain control transistor DRX may be turned off. Accordingly, capacitance of the floating diffusion node FD may be determined to be relatively low, and the conversion gain of the pixel PX may be increased. In a state in which the transfer transistor TX turned off, the pixel PX may output the reset voltage to the column line COL, and thereafter, in a state in which the transfer transistor TX is turned on, at least a portion of the electric charges of the photodiode PD may be transferred to the floating diffusion node FD, and the signal voltage may be output to the column line COL.

Referring to FIG. 26, in the second readout operation, the gain control transistor DRX may be turned on. Accordingly, capacitance of the floating diffusion node FD may be determined to be relatively high, and the conversion gain of the pixel PX may be decreased. Since the capacitor CAP is connected to the floating diffusion node FD, and the second node N2 to which the capacitor CAP is connected may be floated, capacitance of the second node N2 may be dominantly added to the floating diffusion node FD, such that degradation of a signal-to-noise ratio due to excessive reduction of the conversion gain may be prevented.

In the second readout operation, the pixel PX may output a signal voltage through the column line COL after the transfer transistor TX is turned on and electric charges remaining in the photodiode PD may be transferred to the floating diffusion node FD. The reset voltage under the relatively low conversion gain condition may be output by the pixel PX before the exposure time ends and the first readout operation starts as described with reference to FIG. 13 above.

Referring to FIG. 27, in the third readout operation, the gain control transistor DRX and the second switch transistor SW2 may be turned on. Accordingly, electric charges generated during the exposure time exceeding the FWC of the photodiode PD and stored in the capacitor CAP may move to the floating diffusion node FD. In the third readout operation, the pixel PX may output the signal voltage after the transfer transistor TX is turned on. After the signal voltage is output, the reset transistor RX may be turned on by the row driver and electric charges of the floating diffusion node FD are removed, and the pixel PX may output the reset voltage to the column line COL.

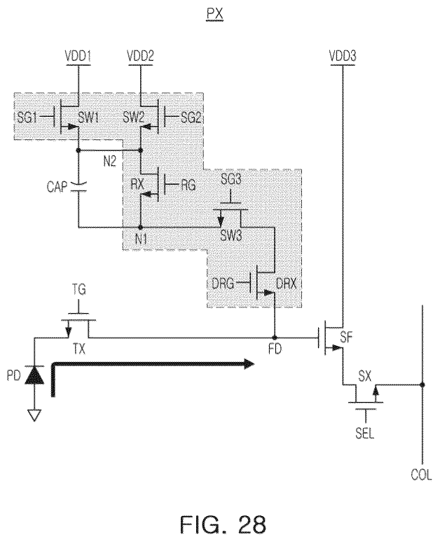

FIGS. 28 to 30 are diagrams illustrating operations of an image sensor according to one or more embodiments.

Referring to FIGS. 28 to 30, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a second switch transistor SW2, a third switch transistor SW3, a reset transistor RX, an amplification transistor SF, and a select transistor SX. A plurality of transistors included in the pixel circuit may be controlled by control signals TG, RG, SG1, SG2, SG3, DRG, and SEL output by a row driver. In a pixel PX according to one or more embodiments described with reference to FIGS. 28 to 30, a third switch transistor SW3 may be connected between the first node N1 and the gain control transistor DRX.

FIGS. 28 to 30 may be diagrams illustrating first to third readout operations, respectively. Referring to FIG. 28 illustrating a first readout operation under a relatively high conversion gain condition, in the first readout operation, the first to third switch transistors SW1-SW3, the reset transistor RX, and the gain control transistor DRX may be turned off. Accordingly, capacitance of the floating diffusion node FD may be determined to be relatively low, and the conversion gain of the pixel PX may be increased. In a state in which the transfer transistor TX is turned off, the pixel PX may output a reset voltage to the column line COL, and thereafter, in a state in which the transfer transistor TX is turned on, and at least a portion of electric charges of the photodiode PD are transferred to the floating diffusion node FD, a signal voltage may be output to the column line COL.

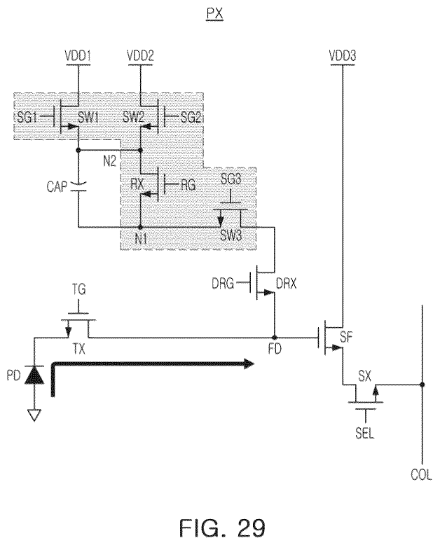

Referring to FIG. 29 illustrating a second readout operation under a relatively low conversion gain condition, the gain control transistor DRX may be turned on in the second readout operation. Accordingly, capacitance of the floating diffusion node FD may be determined to be relatively high, and the conversion gain of the pixel PX may be decreased.

In the embodiment illustrated in FIG. 29, since the third switch transistor SW3 maintains the turned-off state, the floating diffusion node FD and the capacitor CAP may be electrically isolated and disconnected from each other. As described above with reference to FIG. 3, the capacitor CAP may be disposed in a position relatively close to the second layer L2, in which the peripheral circuit is disposed, within the first layer L1 in which the pixel PX is formed, and accordingly, noise generated by the operations of the peripheral circuit may flow in through the capacitor CAP.

In one or more embodiments illustrated in FIG. 29, since the turned-off third switch transistor SW3 is connected between the capacitor CAP and the floating diffusion node FD, noise flowing in from the peripheral circuit to the capacitor CAP may not be transmitted to the floating diffusion node FD. Accordingly, noise properties of the image sensor may be improved, and a shielding layer may not be provided between the capacitor CAP and the peripheral circuit.

In the second readout operation, after the transfer transistor TX is turned on and electric charges remaining in the photodiode PD move to the floating diffusion node FD, the pixel PX may output a signal voltage through the column line COL. The reset voltage under the relatively low conversion gain condition may be output by the pixel PX before the exposure time ends and the first readout operation starts as described above with reference to FIG. 13.

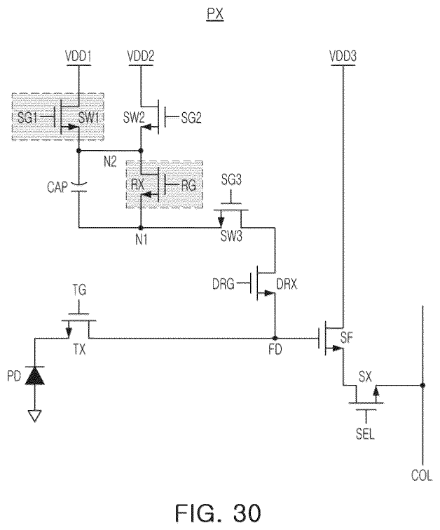

Referring to FIG. 30, in the third readout operation, the gain control transistor DRX, the second switch transistor SW2 and the third switch transistor SW3 may be turned on. Accordingly, electric charges generated by exceeding the FWC of the photodiode PD during the exposure time and stored in the capacitor CAP may move to the floating diffusion node FD. In the third readout operation, the pixel PX may output the signal voltage after the transfer transistor TX is turned on. After the signal voltage is output, when the reset transistor RX is turned on by the row driver and electric charges of the floating diffusion node FD are removed, the pixel PX may output the reset voltage to the column line COL.

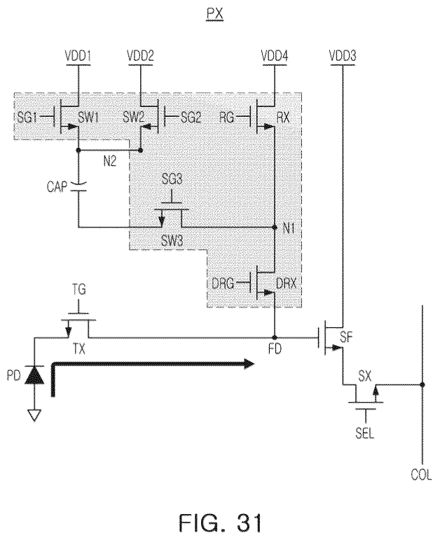

FIGS. 31 to 33 are diagrams illustrating operations of an image sensor according to one or more embodiments.

Referring to FIGS. 31 to 33, a pixel PX according to one or more embodiments may include a photodiode PD and a pixel circuit, and the pixel circuit may include a floating diffusion node FD, a transfer transistor TX, a gain control transistor DRX, a capacitor CAP, a first switch transistor SW1, a second switch transistor SW2, a third switch transistor SW3, a reset transistor RX, an amplification transistor SF, and a select transistor SX. A plurality of transistors included in the pixel circuit may be controlled by control signals TG, RG, SG1, SG2, SG3, DRG, and SEL output by the row driver. In a pixel PX according to one or more embodiments described with reference to FIGS. 31 to 33, a third switch transistor SW3 may be connected between a first node N1 and a gain control transistor DRX, and a reset transistor RX may be connected between a fourth power node and the first node N1.

FIGS. 31 to 33 may be diagrams illustrating first to third readout operations, respectively. Referring to FIG. 31 illustrating a first readout operation under a relatively high conversion gain condition, in the first readout operation, first to third switch transistors SW1-SW3, reset transistor RX, and gain control transistor DRX may be turned off. Accordingly, capacitance of the floating diffusion node FD may be determined to be relatively low, and the conversion gain of the pixel PX may be increased. The pixel PX may output a reset voltage and a signal voltage in sequence to the column line COL, and before outputting the signal voltage, the transfer transistor TX may be turned on such that at least a portion of the electric charges of the photodiode PD may move to the floating diffusion node FD.

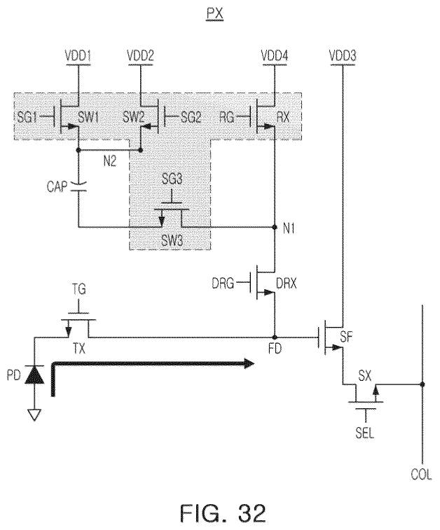

Referring to FIG. 32 illustrating a second readout operation under a relatively low conversion gain condition, in the second readout operation, the gain control transistor DRX may be turned on. Accordingly, capacitance of the floating diffusion node FD may be determined to be relatively high, and the conversion gain of the pixel PX may be reduced. Similarly to the embodiment described with reference to FIGS. 28 to 30 above, since the third switch transistor SW3 maintains the turned-off state, the floating diffusion node FD and the capacitor CAP may be electrically isolated and disconnected from each other, and noise generated by operations of the peripheral circuit may be blocked from flowing into the floating diffusion node FD through the capacitor CAP, thereby addressing noise properties of the image sensor.

In the second readout operation, after the transfer transistor TX is turned on and the electric charges remaining in the photodiode PD are transferred to the floating diffusion node FD, the pixel PX may output a signal voltage through the column line COL. The reset voltage under the relatively low conversion gain condition may be output by the pixel PX before the exposure time ends and the first readout operation starts as described with reference to FIG. 13 above.

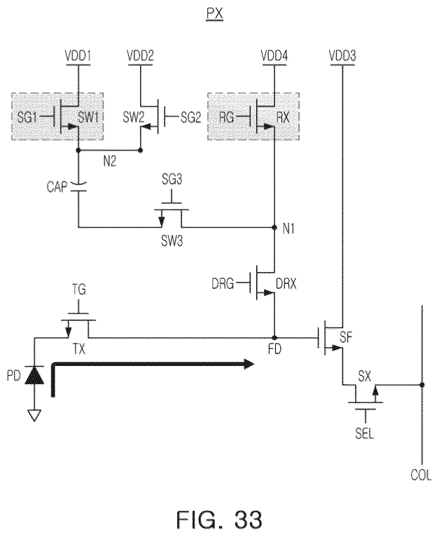

Referring to FIG. 33, in the third readout operation, the gain control transistor DRX, the second switch transistor SW2 and the third switch transistor SW3 may be turned on. Accordingly, electric charges generated by exceeding the FWC of the photodiode PD during the exposure time and stored in the capacitor CAP may move to the floating diffusion node FD. In the third readout operation, the pixel PX may output the signal voltage after the transfer transistor TX is turned on. After the signal voltage is output, when the reset transistor RX is turned on by the row driver and the electric charges of the floating diffusion node FD are removed, the pixel PX may output the reset voltage to the column line COL.

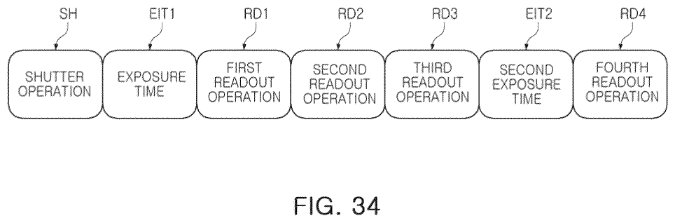

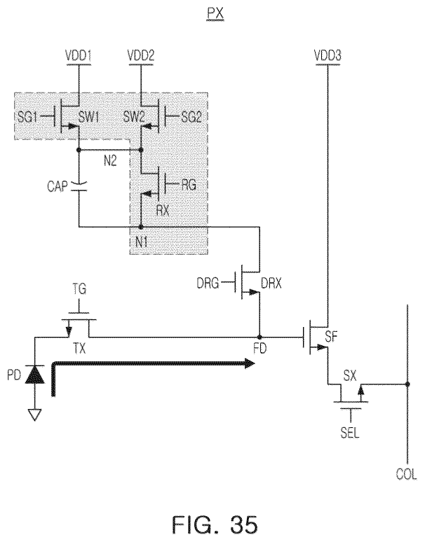

FIGS. 34 and 35 are diagrams illustrating operations of an image sensor according to one or more embodiments.

FIG. 34 may be a diagram illustrating operations of a pixel included in an image sensor according to one or more embodiments. In one or more embodiments, pixels included in a pixel array may be arranged in a row direction and a column direction, may be connected to a row driver in the row direction, and may be connected to a readout circuit in the column direction. The row driver may simultaneously drive pixels arranged in the row direction, and accordingly, an operation illustrated in FIG. 34 may be simultaneously executed in two or more pixels arranged in the row direction.

The operations of the pixel may include a shutter operation SH, a first exposure time EIT1, first to third readout operations RD1-RD3, a second exposure time EIT2, and a fourth readout operation RD4. In the shutter operation SH, electric charges of a photodiode and a floating diffusion node may be removed. For example, in the shutter operation SH, the photodiode and the floating diffusion node may be electrically connected to at least one of the power nodes.

During the first exposure time EIT, the photodiode may be exposed to light and generate electric charges. For example, during the first exposure time EIT1, the photodiode and the floating diffusion node may be electrically isolated and disconnected from each other, and electric charges generated by the photodiode may not move to the floating diffusion node. However, in an environment in which intensity of light entering the photodiode is relatively strong, electric charges may be generated by exceeding the FWC of the photodiode. In this case, the electric charges generated by exceeding the FWC of the photodiode may move to the capacitor along a leakage path and may be stored therein.

The first readout operation RD1 may be executed under a condition in which the pixel has a relatively high conversion gain, and the second readout operation RD2 may be executed under a condition in which the pixel has a relatively low conversion gain. In the third readout operation RD3, the pixel may output a signal voltage corresponding to electric charges generated by exceeding the FWC of the photodiode and stored in the capacitor. The readout circuit of the image sensor may cover a relatively wide range of illuminance using pixel signals obtained from the first readout operation RD1, the second readout operation RD2, and the third readout operation RD3, and accordingly, the dynamic range of the image sensor may be improved.

In one or more embodiments illustrated in FIG. 34, the second exposure time EIT2 and the fourth readout operation RD4 may be executed after the third readout operation RD3. In one or more embodiments, during the second exposure time EIT2, the pixel may execute a multiple exposure operation. In the fourth readout operation, the pixel may output a signal voltage generated by the photodiode during the second exposure time EIT2 after outputting a reset voltage.

FIG. 35 may be a drawing illustrating the fourth readout operation. Referring to FIG. 35, in the fourth readout operation, a gain control transistor DRX may be turned on. Accordingly, capacitance of the floating diffusion node FD may extend by the gain control transistor DRX. When a pixel executes a multiple exposure operation during the second exposure time EIT2, the pixel signal output by the pixel in the fourth readout operation may provide an illuminance range greater than an illuminance range of the pixel signal output by the pixel in the first to third readout operations. Accordingly, by the second exposure time EIT2 and the fourth readout operation, the dynamic range of the image sensor may be further extended.

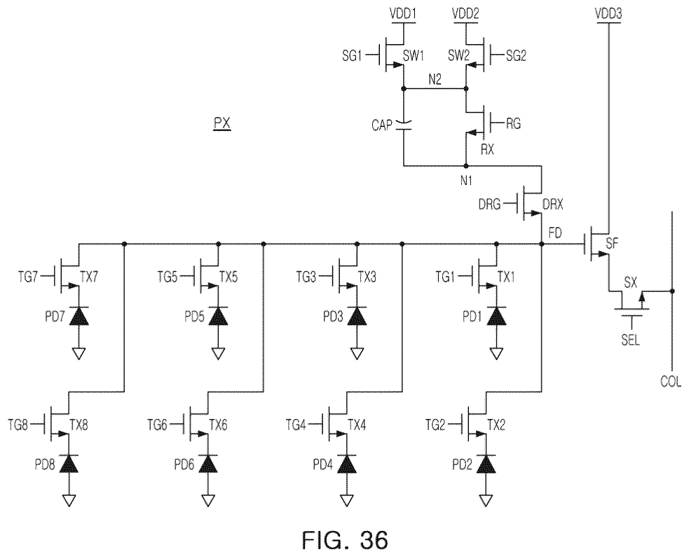

FIG. 36 is a diagram illustrating a pixel included in an image sensor according to one or more embodiments.

Referring to FIG. 36, a pixel PX according to one or more embodiments may include a photodiode PD and a pixel circuit. The pixel circuit may include a floating diffusion node FD, a gain control transistor DRX, a capacitor CAP, a first switch transistor SW1, a second switch transistor SW2, a reset transistor RX, an amplification transistor SF, and a select transistor SX. Control signals TG1 to TG8, RG, SG1, SG2, DRG, and SEL controlling the plurality of transistors included in the pixel circuit may be output by a row driver (e.g., the row driver 31 of FIG. 1).

In the embodiment illustrated in FIG. 36, eight photodiodes PD1 to PD8 and eight transfer transistors TX1 to TX8 may share the floating diffusion FD. The eight photodiodes PD1 to PD8 may be disposed in 4×2 matrix form or in 2×4 matrix form in a pixel array. The eight photodiodes PD1 to PD8 and the eight transfer transistors TX1 to TX8 may share the pixel circuit, and the pixel circuit may generate and output a signal corresponding to electric charges generated by at least one of the eight photodiodes PD1 to PD8. For example, various embodiments described above may be applied to the pixel PX illustrated in FIG. 36.

According to the aforementioned one or more embodiments, each of the pixels may include a photodiode and a pixel circuit, and the pixel circuit may include a plurality of transistors and at least one capacitor. In one or more embodiments, by appropriately limiting capacitance of the floating diffusion node in each of a readout operation executed under a relatively high conversion gain condition and a readout operation executed under a relatively low conversion gain condition, the signal-to-noise ratio may be improved and the dynamic range may be improved. Also, in one or more embodiments, by changing the voltage applied to the capacitor to turning on/off operation of each of the plurality of switch elements, dark signal non-uniformity (DSNU) of the image sensor may be addressed.

While embodiments have been illustrated and described above, it will be configured as apparent to those skilled in the art that modifications and variations could be made without departing from the scope of the present disclosure as defined by the appended claims and their equivalents.

What is claimed is:

1. An image sensor, comprising:
a pixel array comprising a plurality of pixels,
wherein each pixel of the plurality of pixels comprises a first photodiode and a pixel circuit configured to output a first signal corresponding to electric charges generated by the first photodiode, and
wherein the pixel circuit comprises:
a floating diffusion node configured to store the electric charges generated by the first photodiode;
a transfer transistor between the first photodiode and the floating diffusion node;
a gain control transistor connected to the floating diffusion node;
a capacitor and a first switch transistor connected in series between the gain control transistor and a first power node;
a reset transistor between the gain control transistor and a second power node;
an amplification transistor comprising a gate connected to the floating diffusion node; and
a select transistor between the amplification transistor and at least one column line of the plurality of column lines.

2. The image sensor of claim 1, wherein the first power node is configured to supply a first power voltage, and the second power node is configured to supply a second power voltage different from the first power voltage.

3. The image sensor of claim 1, wherein each pixel of the plurality of pixels further comprises a second photodiode.

4. The image sensor of claim 3, wherein the pixel circuit in each pixel of the plurality of pixels configured to output a second signal corresponding to electric charges generated by the first and second photodiodes.

5. The image sensor of claim 4, wherein each pixel of the plurality of pixels further comprises a third photodiode and a fourth photodiode, and
wherein the pixel circuit in each pixel of the plurality of pixels configured to output a third signal corresponding to electric charges generated by the first to fourth photodiodes.

6. The image sensor of claim 1, wherein the pixel circuit further comprises a second switch transistor between the reset transistor and the second power node.

7. The image sensor of claim 6, wherein the capacitor and the reset transistor are connected to each other in parallel between a first node and a second node,
wherein the first node is connected to the capacitor and the reset transistor, and
wherein the second node is connected to the first switch transistor, the capacitor, the reset transistor, and the second switch transistor.

8. The image sensor of claim 7, wherein the pixel circuit further comprises a third switch transistor between the first node and the gain control transistor.

9. The image sensor of claim 1, wherein a drain of the reset transistor is connected to the second power node, and a source of the reset transistor is connected to the capacitor and the gain control transistor.

10. The image sensor of claim 1, wherein the first power node and the second power node are configured to supply the same power voltage, and the reset transistor is connected to the capacitor in parallel.

11. The image sensor of claim 1, wherein the pixel circuit further comprises a second switch transistor, and
wherein a drain of the second switch transistor is connected to a fourth power node, and a source of the second switch transistor is connected to a node between the first switch transistor and the capacitor.

12. The image sensor of claim 1, wherein the amplification transistor is connected to a third power node, and
wherein the third power node is configured to supply a third power voltage that is different from the first power voltage.

13. The image sensor of claim 11, wherein a drain of the reset transistor is connected to the second power node, and a source of the reset transistor is connected to the gain control transistor and the capacitor.

14. The image sensor of claim 11, wherein the pixel circuit further comprises a third switch transistor, and
wherein a drain of the third switch transistor is connected to a node between the reset transistor and the gain control transistor, and a source of the third switch transistor is connected to the capacitor.

15. The image sensor of claim 1, wherein the first power node is configured to supply a first power voltage and to supply a fourth power voltage different from the first power voltage.

16. An image sensor, comprising:
a plurality of pixels,
wherein each pixel of the plurality of pixels comprises a photodiode and a pixel circuit connected to the photodiode,
wherein the pixel circuit comprises:
a transfer transistor between the photodiode and a floating diffusion node;
a capacitor configured to store electric charges generated by the photodiode;
a first switch transistor between the capacitor and a first power node; and
a second switch transistor between the capacitor and a second power node, and
wherein the first power node is in a first mesh pattern configured to supply a first power voltage, and the second power node is in a second mesh pattern configured to supply a second power voltage greater than the first power voltage, the second mesh pattern being electrically disconnected from the first mesh pattern.

17. The image sensor of claim 16, wherein the capacitor comprises a first electrode, a second electrode, and a dielectric layer between the first electrode and the second electrode, and
wherein the first electrode is connected to at least one transistor at a first node, and the second electrode is connected to the first switch transistor and the second switch transistor at a second node.

18. The image sensor of claim 17, wherein the at least one transistor comprises a gain control transistor between the floating diffusion node and the first node.

19. An image sensor, comprising:
a plurality of pixels,
wherein each pixel of the plurality of pixels comprises a photodiode and a pixel circuit connected to the photodiode,
wherein the pixel circuit comprises:
a transfer transistor between the photodiode and a floating diffusion node;
a gain control transistor between the floating diffusion node and a first node;
a capacitor between the first node and a second node;
at least one switch transistor between the second node and a power node;
a reset transistor connected to the first node;
an amplification transistor comprising a gate connected to the floating diffusion node; and
a select transistor between the amplification transistor and a column line.

20. The image sensor of claim 19, wherein the power node comprises a first power node configured to supply a first power voltage, and a second power node configured to supply a second power voltage different from the first power voltage, and
wherein the at least one switch transistor comprises a first switch transistor between the first power node and the second node.
